(19) United States
(12) Patent Application Publication
(10) Pub. No.: US 2005/0091303 A1
(43) Pub. Date: Apr. 28, 2005

(54) Flow control system and method therefor

(75) Inventor: Yuichi Suzuki, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 10/953,326

(22) Filed: Sep. 29, 2004

(30) Foreign Application Priority Data
Oct. 1, 2003 (JP) 2003-342869

(51) Int. Cl. G06F 15/16

(52) U.S. Cl. 709/200

(57) ABSTRACT

A flow control server forecasts a fluctuation in the traffic on a network to be controlled, on the basis of an information set on itself and a result of searching information on the Internet. The flow control server issues a flow control command to a management server so as to prevent a congestion in the network on the basis of the forecast. The management server controls a routing information of each router on the basis of the flow control command from the flow control server, and sends out a routing control command to each router based on the control. Each router carries out the routing control by setting its own routing information on the basis of the routing control command received from the management server, in order to realize the flow control.

### BACKGROUND OF THE INVENTION

1. Field of the Invention

The present invention relates to a flow control system and a method for controlling a flow in a network system having a router which carries out routing control on the basis of routing information.

2. Description of the Related Art

Recent development in network service is outstanding, and traffic on a network variously increases and decreases in accordance with the contents of service provided by the network service.

A flow on the network includes a flow related to VoIP (voice over IP (internet protocol)), a flow related to financial business information, and the like. In such flows, a user runs into trouble if delay in the transmission of data transmitted by the flow is long or data is lost. How to control and deal with such flows is an important subject in the field of network technology.

In a conventional method for controlling this type of flow (flow control system), information indicating a state of fluctuation in the traffic on the network (traffic fluctuation information) is collected from each router, and flow control is carried out in accordance with such traffic fluctuation information. Taking a case of a method and a system for transmitting packets disclosed in Japanese Patent Laid-Open Publication No. 2003-78549, for example, a router on the Internet carries out band monitoring, priority transmission, and flow-to-flow statistical information collection, on the basis of a flow identifier which is uniquely assigned on the Internet.

In the foregoing conventional flow control system, as described above, the flow control is carried out in accordance with the traffic fluctuation information collected from each router. Thus, when the traffic abruptly fluctuates, the flow control cannot deal with (cannot meet) the fluctuation. Therefore, there are problems that the transmission of data to be transmitted (data transmitted by a flow to be controlled) may be delayed, and data may be lost.

In other words, since the fluctuation in the traffic cannot be forecasted in advance in the conventional technology, a situation in which a band necessary for the flow to be controlled cannot be secured may occur. Also, there is a problem that the conventional technology cannot properly deal with the fluctuation in the traffic which an administrator has not expected.

### SUMMARY OF THE INVENTION

An object of the present invention is to provide a flow control system which searches information related to fluctuation in traffic (information affecting the fluctuation in the traffic) on the Internet, and forecasts the fluctuation (variation) in the traffic in advance on the basis of the searched information to carry out flow control, for the purpose of solving the foregoing problems.

As a concrete method for controlling a flow according to the present invention, the following methods “a” and “b” are conceivable.
a. A method for carrying out routing control with a margin in a band of a flow to be controlled, before actual traffic is increased.
b. A method in which all of routers and a management server, which compose a network to be controlled, have QoS (quality of service) function for carrying out priority control of a flow, and QoS control is carried out together with the routing control described above “a.”

A flow control system according to the present invention controls a flow on a network, which has a router group for carrying out routing control. The flow control system has a flow control server and a management server. The flow control server forecasts fluctuation in traffic on the network to be controlled on the basis of a result of searching of an information set on itself and an information on the Internet, and issues a flow control command on the basis of the forecast to prevent congestion in the network. The management server controls routing information of each router on the basis of the flow control command from the flow control server, and sends out a routing control command to each router on the basis of the control. Each router carries out the routing control by setting its own routing information on the basis of the routing control command received from the management server, to realize flow control.

To be more specific, a flow control system according to the present invention controls a flow on a network, which has a router group for carrying out routing control. The flow control system comprises a flow control server and a management server. The flow control server comprises an information setting unit, an information updating and adding unit, and a flow control commanding unit. The information setting unit sets the flow control information and the traffic fluctuation information on the flow control server. The flow control information is necessary for carrying out flow control of the flow to be controlled, and indicates the contents of the flow. The traffic fluctuation information indicates a criterion of fluctuation in traffic on the network to be controlled. The information updating and adding unit in the flow control server updates the corresponding traffic fluctuation information, when the change in the contents of the preset traffic fluctuation information is detected on the basis of a result of searching information on the Internet. The information updating and adding unit adds the similar traffic fluctuation information to the flow control server as new traffic fluctuation information, when the presence of the similar traffic fluctuation information, which is the information similar/related to the traffic fluctuation information, is detected. The flow control commanding unit forecasts the fluctuation in the traffic of each route on the network related to the flow to be controlled on the basis of a latest traffic fluctuation information group including update and addition by the information updating and adding unit. Then, the flow control commanding unit determines the contents of the flow control after that point in time on the basis of a forecast result, and sends out a flow control command indicating the contents of the control. The management server controls the routing information of each router on the basis of the flow control command from the flow control server, and sends out a routing control command, which indicates the routing information determined by the control, to each router. Each router carries out the routing control by setting its own routing information on the basis of the routing control command received from the management server, so that the flow control is realized.

Another flow control system according to the present invention controls a flow on a network, which has a router group for carrying out routing control. The flow control system comprises a flow control server and a management server. The flow control server comprises an information setting unit, an information updating and adding unit, and a flow control commanding unit. The information setting unit sets a flow control information and a traffic fluctuation information on the flow control server. The flow control information is necessary for carrying out flow control of the flow to be controlled, and indicates the contents of the flow. The traffic fluctuation information indicates a criterion of fluctuation in traffic on the network to be controlled. The information updating and adding unit in the flow control server updates the corresponding traffic fluctuation information, when the change in the contents of the preset traffic fluctuation information is detected on the basis of a result of searching information on the Internet. The information updating and adding unit adds similar traffic fluctuation information to the flow control server as a new traffic fluctuation information, when the presence of the similar traffic fluctuation information, which is the information similar/related to the traffic fluctuation information, is detected. The flow control commanding unit forecasts the fluctuation in the traffic of each route on the network related to the flow to be controlled on the basis of a latest traffic fluctuation information group including update and addition by the information updating and adding unit. Then, the flow control commanding unit determines the contents of the flow control after that point in time on the basis of a forecast result, and sends out a flow control command indicating the contents of the control. The management server (management server with QoS function) controls a routing information and an information related to the QoS function of each router (router with the QoS function) on the basis of the flow control command from the flow control server, and sends out a routing control/QoS control command, which indicates the routing information and the information related to the QoS function determined by the control, to each router. Each router carries out the routing control by setting its own routing information on the basis of the routing control/QoS control command from the management server, and carries out QoS control on the basis of the routing control/QoS control command, in order to realize the flow control.

On the other hand, in a network system in which a flow is controlled on a network having a router group for carrying out a routing control, a method for controlling a flow according to the present invention comprises the following steps. In a first step, a flow control information is set on a flow control server. In a second step, a traffic fluctuation information group is set on the flow control server. In a third step, the flow control server monitors the presence or absence of the change in the contents of the traffic fluctuation information at regular intervals. In a fourth step, the traffic fluctuation information is updated, when the presence of the change in the contents of the traffic fluctuation information is detected in the third step. In a fifth step, the flow control server monitors the presence or absence of a similar traffic fluctuation information at regular intervals. In a sixth step, the similar traffic fluctuation information is added as a new traffic fluctuation information, when the presence of the similar traffic fluctuation information is detected in the fifth step. In a seventh step, the flow control server forecasts the fluctuation in traffic on the network to be controlled on the basis of a latest traffic fluctuation information group, in which update in the fourth step and addition in the sixth step are reflected. In an eighth step, the flow control server sends out a flow control command on the basis of a forecast about the traffic fluctuation in the seventh step to a management server. In a ninth step, the management server controls the routing information of each router on the basis of the flow control command in the eighth step. In a tenth step, the management server sends out a routing control command to each router on the basis of the control of the routing information in the ninth step. In an eleventh step, each router carries out the routing control on the basis of the routing control command in the tenth step.

In a network system in which a flow is controlled on a network having a router group for carrying out a routing control, another method for controlling a flow according to the present invention comprises the following steps. In a first step, a flow control information is set on a flow control server. In a second step, a traffic fluctuation information group is set on the flow control server. In a third step, the flow control server monitors the presence or absence of the change in the contents of the traffic fluctuation information at regular intervals. In a fourth step, the traffic fluctuation information is updated, when the presence of the change in the contents of the traffic fluctuation information is detected in the third step. In a fifth step, the flow control server monitors the presence or absence of a similar traffic fluctuation information at regular intervals. In a sixth step, the similar traffic fluctuation information is added as a new traffic fluctuation information, when the presence of the similar traffic fluctuation information is detected in the fifth step. In a seventh step, the flow control server forecasts the fluctuation in traffic on the network to be controlled on the basis of a latest traffic fluctuation information group, in which update in the fourth step and addition in the sixth step are reflected. In an eighth step, the flow control server sends out a flow control command on the basis of a forecast about traffic fluctuation in the seventh step to a management server (management server with QoS function). In a ninth step, the management server controls a routing information and an information related to the QoS function of each router (router with the QoS function) on the basis of the flow control command in the eighth step. In a tenth step, the management server sends out a routing control/QoS control command to each router, on the basis of the control of the routing information and the information related to the QoS function in the ninth step. In an eleventh step, each router carries out the routing control and the QoS control on the basis of the routing control/QoS control command in the tenth step.

Furthermore, the present invention may be realized in a form of a program, on the precondition that a management server and routers are exist in a network system including a network having a router group for carrying out a routing control. The management server controls routing information of each router on the basis of a flow control command from a flow control server, and sends out a routing control command, which indicates the routing information determined by the control, to each router. Each router carries out the routing control by setting its own routing information on the basis of the routing control command received from the management server, in order to realize a flow control. The program makes the flow control server function as information setting means, information updating and adding means, and flow control commanding means. The information setting means sets a flow control information and a traffic fluctuation information on the flow control server. The flow control information is necessary for carrying out the flow control of a flow to be controlled, and indicates the contents of the flow. The traffic fluctuation information indicates a criterion of the traffic fluctuation on the network to be controlled. The information updating and adding means updates the corresponding traffic fluctuation information, when the change in the contents of the preset traffic fluctuation information is detected on the basis of a result of the searching information on the Internet. The information updating and adding means adds the similar traffic fluctuation information to the flow control server as a new traffic fluctuation information, when the presence of the similar traffic fluctuation information, which is the information similar/related to the traffic fluctuation information, is detected. The flow control commanding means forecasts the fluctuation in traffic of each route on the network related to the flow to be controlled on the basis of a latest traffic fluctuation information group including update and addition by the information updating and adding means. Then, the flow control commanding means determines the contents of the flow control after that point in time on the basis of a forecast result, and sends out a flow control command indicating the contents of the control to the management server.

Additionally, the present invention may be realized in a form of a program, on the precondition that a management server (management server with QoS function) and routers (router with the QoS function) are exist in a network system including a network having a router group for carrying out a routing control. The management server controls a routing information and an information related to the QoS function of each router on the basis of a flow control command from a flow control server, and sends out a routing control/QoS control command, which indicates the routing information and the information related to the QoS function determined by the control, to each router. Each router carries out routing control by setting its own routing information on the basis of the routing control/QoS control command from the management server, and carries out the QoS control on the basis of the routing control/QoS control command, in order to realize flow control. The program makes the flow control server function as information setting means, information updating and adding means, and flow control commanding means. The information setting means sets a flow control information and a traffic fluctuation information on the flow control server. The flow control information is necessary for carrying out the flow control of a flow to be controlled, and indicates the contents of the flow. The traffic fluctuation information indicates a criterion of the traffic fluctuation on the network to be controlled. The information updating and adding means updates the corresponding traffic fluctuation information, when the change in the contents of the preset traffic fluctuation information is detected on the basis of a result of the searching information on the Internet. The information updating and adding means adds similar traffic fluctuation information to the flow control server as a new traffic fluctuation information, when the presence of the similar traffic fluctuation information, which is the information similar/related to the traffic fluctuation information, is detected. The flow control commanding means forecasts the fluctuation in traffic of each route on the network related to the flow to be controlled on the basis of a latest traffic fluctuation information group including update and addition by the information updating and adding means. Then, the flow control commanding means determines the contents of the flow control after that point in time on the basis of a forecast result, and sends out a flow control command indicating the contents of the control to the management server.

According to the present invention, as described above, the information related to the fluctuation in the traffic (information affecting the fluctuation in the traffic) is searched on the Internet, and the fluctuation in the traffic is forecasted in advance on the basis of the searched information before carrying out the flow control. Thus, concrete effects such as the following “a” and “b” occur, so that it is possible to prevent delay in the transmission of data to be transmitted (data transmitted by a flow to be controlled) and loss of data.
a. It is possible to properly secure a band necessary for the flow to be controlled, on the basis of the prior forecast about the fluctuation in the traffic.
b. It is possible to properly deal with the fluctuation (variation) in the traffic which an administrator has not expected.

### BRIEF DESCRIPTION OF THE DRAWINGS

FIG. 1 is a block diagram showing the configuration of a flow control system in the best mode for carrying out the present invention;

FIG. 2 is a block diagram showing the configuration of a flow control system according to a first embodiment of the present invention;

FIG. 3 is a flowchart which shows processing of a flow control server in the flow control system shown in FIG. 2 and a flow control system shown in FIG. 6, and is also a flowchart which shows processing procedure in flow control methods according to third and fourth embodiments of the present invention;

FIG. 4 is a flowchart which shows processing of an management server and each router in the flow control system shown in FIG. 2, and is also a flowchart which shows processing procedure in the flow control method according to the third embodiment of the present invention;

FIG. 5 is a block diagram showing the operation of the flow control system shown in FIG. 2;

FIG. 6 is a block diagram showing the configuration of a flow control system according to a second embodiment of the present invention;

FIG. 7 is a flowchart which shows processing of a management server and each router in the flow control system shown in FIG. 6, and is also a flowchart which shows processing procedure in the flow control method according to the fourth embodiment of the present invention;

FIG. 8 is a block diagram showing the configuration of a fifth embodiment of the present invention; and

FIG. 9 is a block diagram showing the configuration of a sixth embodiment of the present invention.

### DETAILED DESCRIPTION OF THE PREFERRED EMBODIMENT

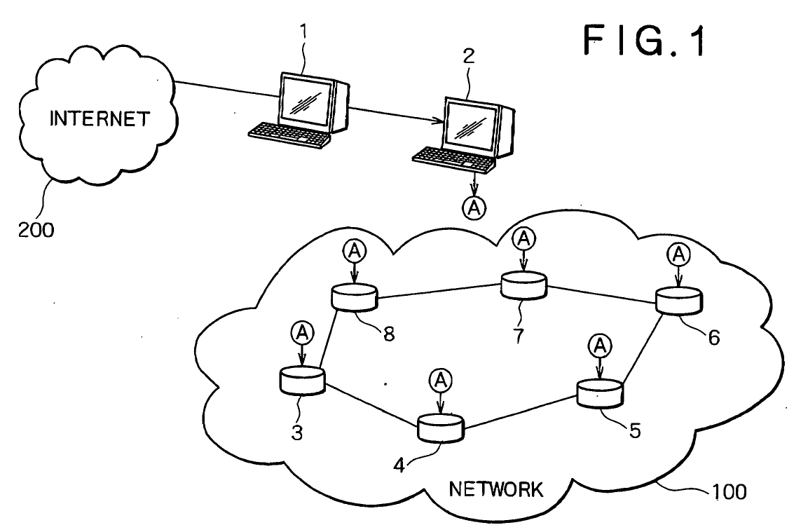

Embodiments of the present invention will be hereinafter described in detail with reference to the accompanying drawings. FIG. 1 is a block diagram showing a concept of a flow control system according to the present invention. This flow control system comprises a flow control server 1, a management server 2, a network 100 having routers 3, 4, 5, 6, 7, and 8 (the network includes a plurality of networks which are connected to each other by the respective routers 3 to 8), and the Internet 200. In FIG. 1, the arrows indicate commands for flow control from the flow control server 1 to the routers 3, 4, 5, 6, 7, and 8 in the network 100 through the management server 2. As a matter of course, the number of the routers is not limited to that in the drawing.

In the flow control system, as shown in FIG. 1, the flow control server 1 and the management server 2 are connected to each other, and the routers 3 to 8 are placed under the control of the management server 2. The flow control server 1 connected to the Internet 200 has the function of searching information disseminated to the Internet 200.

The concrete embodiments (including embodiments in a category different from that of FIG. 1) of the foregoing flow control system according to the present invention will be hereinafter described.

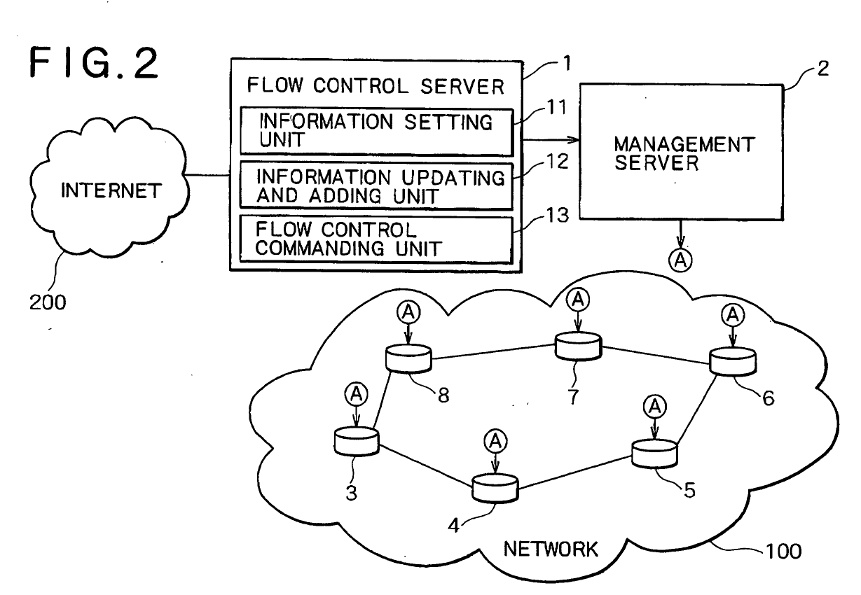

FIG. 2 is a block diagram showing the structure of a flow control system according to a first embodiment of the present invention. The flow control system according to this embodiment comprises a flow control server 1, a management server 2, a network 100 (the network includes a plurality of networks which are connected to each other by the respective routers 3 to 8), and the Internet 200. The flow control server 1 has information setting unit 11, information updating and adding unit 12, and flow control commanding unit 13. The management server 2 has the function of controlling (collectively managing) routing information of each router 3 to 8. The network 100 has the routers 3, 4, 5, 6, 7, and 8 which have function of carrying out flow control by controlling its own routing information (routing control).

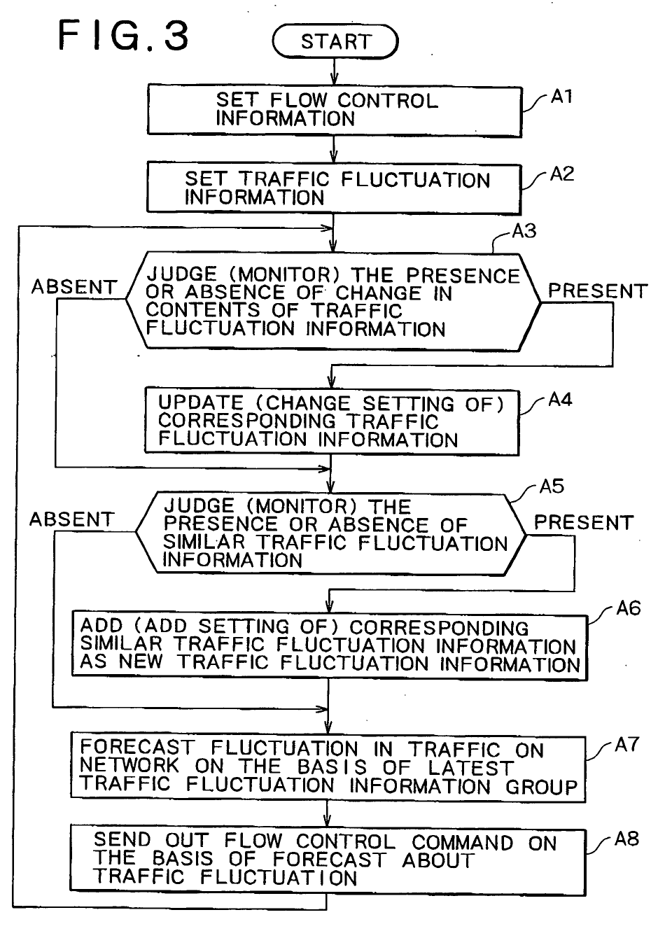

FIG. 3 is a flowchart which shows processing of the flow control server 1 in the flow control system shown in FIG. 2. The processing includes a step A1 of setting flow control information, a step A2 of setting traffic fluctuation information, a step A3 of judging presence or absence of change in the contents of traffic fluctuation information, a step A4 of updating traffic fluctuation information, a step A5 of judging presence or absence of similar traffic fluctuation information, a step A6 of adding traffic fluctuation information, a step A7 of forecasting traffic fluctuation, and step A8 of sending out a flow control command.

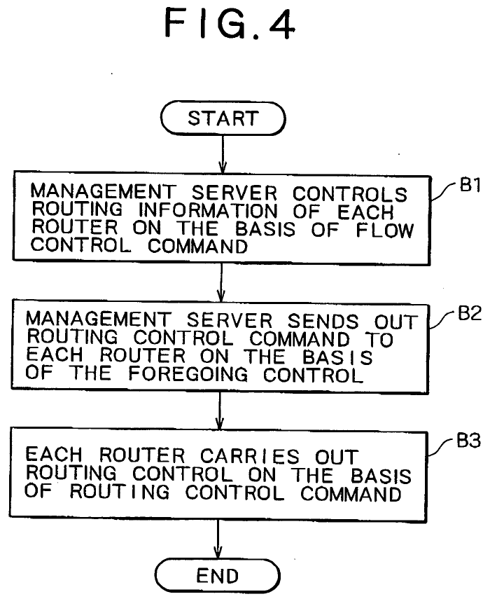

FIG. 4 is a flowchart which shows processing of the management server 2 and each of the routers 3 to 8 in the flow control system shown in FIG. 2. The processing includes a step B1 of controlling routing information, a step B2 of sending out routing control command, and a step B3 of performing routing control.

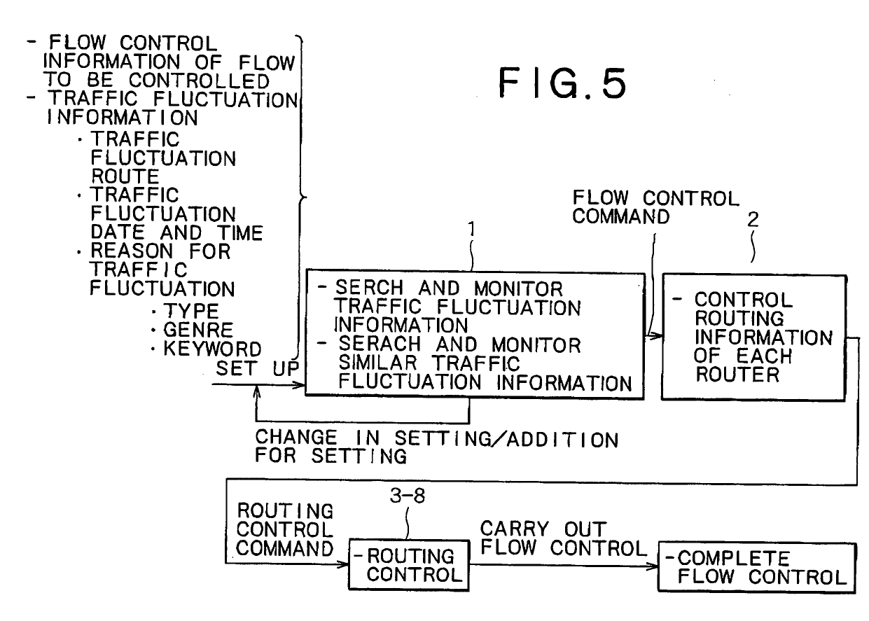

FIG. 5 is a block diagram showing the operation (the setting of information, the flow of commands, and the like) of the flow control system shown in FIG. 2.

Next, the operation of the whole flow control system according to this embodiment, which is configured as above, will be described in detail.

First, the operation of the flow control server 1 will be described. The information setting unit 11 in the flow control server 1 sets up information (called “flow control information”) necessary for controlling a flow (flow to be controlled) in the flow control server 1 (refer to the step A1 of FIG. 3 and FIG. 5). The flow control information corresponds to a flow identifier, IP addresses of a sender and a receiver, TOS (type of service) information, protocol information, priority information such as a flow label, and layer 4 information (a port number and the like) of the flow to be controlled. The flow control information further corresponds to band setting information and priority control setting information with respect to the flow, and information (an IP address and the like) of a router gateway and the like through which the flow passes.

Then, the information setting unit 11 in the flow control server 1 sets traffic fluctuation information, which is information indicating a criterion of traffic fluctuation in the network 100, in the flow control server 1 (step A2). As a concrete content of the foregoing “criterion of the traffic fluctuation,” for example, information expressing a criterion that “traffic increases in a certain route A at a certain date and time B on the basis of a certain reason C” is conceivable (refer to FIG. 5). Therefore, as the foregoing “traffic fluctuation information,” for example, information including A, B, C, and D is conceivable when “traffic increases in a certain route A at a certain date and time B on the basis of a certain reason C by an amount of D.”

The set traffic fluctuation information, as described above, includes a type of traffic (streaming broadcast, ticket reservation, the start of contents download or the like), a genre (can be said “category,” the genre concretely means classification in a search site on the Internet, a portal site, ranking site, or the like), and a specific keyword (the name of a movie, the name of a TV program, the name of an artist, the name of an event, the name of software, the name of update or patch, the name of contents or the like) as the details of the reason, in addition to the route and the date and time in which the traffic increases.

The flow control server 1 repeats the following processing (processing from step A3 to step A8) at regular intervals on the basis of the information (flow control information and traffic fluctuation information) preset as described above, to carry out processing for flow control.

In other words, the information updating and adding unit 12 in the flow control server 1 searches through the Internet 200 by use of information related to the “reason”, which is included in the traffic fluctuation information set in the flow control server 1, as a key (the information updating and adding unit 12 searches through various servers and sites on the Internet 200 for information on the basis of the preset traffic fluctuation information, and takes in the information after sorting out). The information updating and adding unit 12 monitors (judges) the presence or absence of change in the contents of the preset traffic fluctuation information (for example, change in traffic fluctuation time such as change in a date and time for the streaming broadcast, the ticket reservation or the start of contents download) (step A3). When change in the contents of the preset traffic fluctuation information is detected in the step A3, the information updating and adding unit 12 updates (changes setting) the corresponding traffic fluctuation information (step A4).

Next, the information updating and adding unit 12 in the flow control server 1 searches through the Internet 200 for information (called “similar traffic fluctuation information”) similar/related to the traffic fluctuation information set in the flow control server 1, and monitors (judges) the presence or absence of such information (step A5). In other words, the information updating and adding unit 12 searches for the information related to a date and time close to the “date and time” in the traffic fluctuation information, out of information related to, for example, the genre, the name of a movie, the name of a TV program, the name of an artist, the name of an event, the name of software, the name of update or patch, the name of contents or the like, which is related to the “reason” in the preset traffic fluctuation information, with referring to information about popularity in each genre and the frequency of access.

Search and monitoring like this make it possible to cope with the occurrence of “an-administrator-cannot-expect” fluctuations in traffic, which an administrator cannot grasp only by searching and monitoring the conventional traffic fluctuation information set in the step A2, though the traffic is related to fluctuations in traffic indicated by the conventional traffic fluctuation information.

The necessity of monitoring processing in the step A5 will be described. Taking a case of live streaming broadcast of a popular artist, for example, it is conceivable that access related to the broadcast to a website, a bulletin board, a chat room and the like of the artist is increased simultaneously with the broadcast. It is also conceivable that the streaming broadcast is immediately repeated, or data of the streaming broadcast is released by a pirate broadcast or a shared file. Since these events are not announced in advance (officially), it is difficult for the administrator to grasp and set up for the occurrence of traffic due to the events. It is necessary to search and monitor the related information on the Internet 200 in order to find out increase in traffic. A search and monitoring in the step A5 respond to such a request when the information updating and adding unit 12 detects the presence of the corresponding information (the similar traffic fluctuation information) in the step A5, the information updating and adding unit 12 adjusts the similar traffic fluctuation information to the form of the traffic fluctuation information, and adds (adds setting) the information to the flow control server 1 as new traffic fluctuation information (step A6).

Next, the flow control commanding unit 13 in the flow control server 1 forecasts fluctuation (change after that point in time) in the traffic of each route on the network 100 related to the flow to be controlled, on the basis of a latest traffic fluctuation information group including contents updated and added (change in setting and addition of setting in FIG. 5) at the steps A4 and A6 (step A7).

Furthermore, the flow control commanding unit 13 determines the contents of the flow control after that point in time on the basis of a result of the forecast in the step A7. The flow control commanding unit 13 generates a flow control command which indicates the contents of control (the command from the flow control server 1 to the management server 2 indicating how the flow to be controlled travels in the network 100, namely, the command how the flow passes through each router 3 to 8), and sends the flow control command (refer to FIG. 5) to the management server 2 (step A8). In such a manner, the flow control server 1 issues the flow control command to the management server 2 in order to prevent congestion in the network 100.

The flow control server 1 repeatedly and continuously carries out the foregoing flow control processing at regular intervals.

Second, the operation of the management server 2 and each router 3 to 8 will be described.

Generally, each router 3 to 8 dynamically controls the structure and the condition of the network 100 by use of a routing protocol. Since the management server 2 collectively manages setting information of the routing protocol (routing information) of each router 3 to 8, it is possible to set up and change the structure of the network by the routing protocol. The management server 2 can more sensitively manage and control the network 100 by statically setting up the routing information on each router 3 to 8 instead of using the routing protocol.

The management server 2 controls the routing information of each router 3 to 8 on the basis of the flow control command (refer to FIGS. 3 and 5) from the flow control server 1 (step B1 of FIG. 4).

The setting information of the routing protocol corresponds to the routing information when the network 100 is controlled with the use of the routing protocol. The setting information of the static routing information itself corresponds to the routing information when the network 100 is statically controlled without the use of the routing protocol.

Then, the management server 2 sends (issues) a routing control command (refer to FIG. 5) to each router 3 to 8 on the basis of control of the step B1 (in such a manner as to command the routing information determined by the control to each router 3 to 8) (step B2).

Each router 3 to 8 sets its own (each router's 3 to 8) routing information on the basis of the routing control command received from the management server 2 to carry out routing control (step B3), so that flow control according to this embodiment is realized (flow control of a flow to be controlled is completed as shown in FIG. 5).

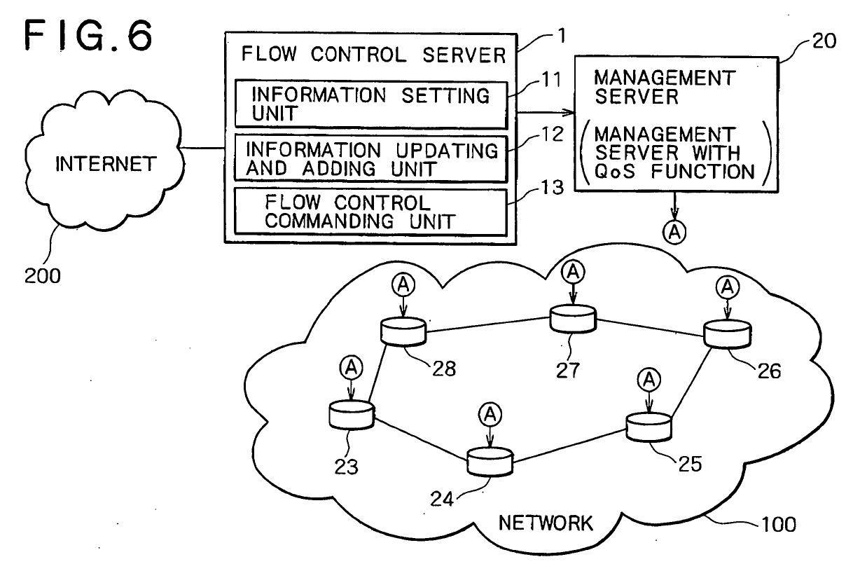

Next, a second embodiment of the present invention will be described. FIG. 6 is a block diagram showing the structure (structure showing the structure of FIG. 1 in detail) of a flow control system according to the second embodiment of the present invention. The flow control system according to the second embodiment comprises a flow control server 1, an management server (management server with QoS function) 20 (this component corresponds to the management server 2 in FIG. 1), a network 100 with routers (routers with the QoS function) 23, 24, 25, 26, 27, and 28 (the network includes a plurality of networks connected to each other by each router 23 to 28), and the Internet 200. The flow control server 1 has information setting unit 11, information updating and adding unit 12, and flow control commanding unit 13. The management server 20 has the function of controlling (collectively managing) routing information of each router 23 to 28 (these components correspond to the routers 3 to 8 in FIG. 1), and the function of carrying out QoS control (QoS function). The routers (routers with the QoS function) 23 to 28 have the function of carrying out flow control by means of routing control by controlling its own routing information, and QoS control. (Not only the router 23 but also the routers 24 to 28 correspond to the “router with the QoS function,” through it is not illustrated in FIG. 6.)

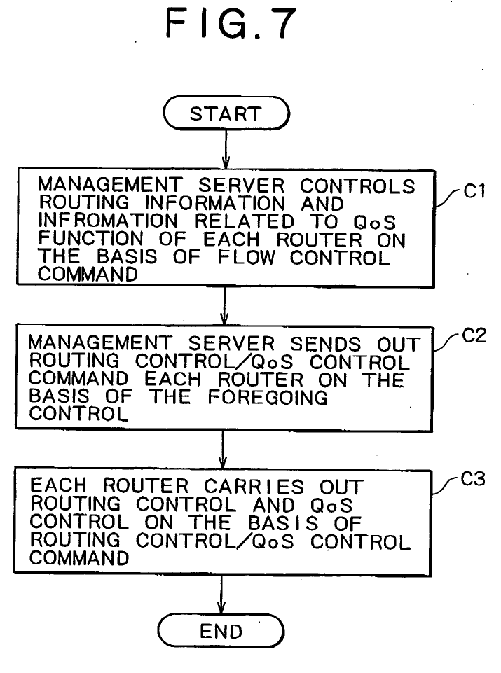

FIG. 7 is a flowchart which shows processing of the management server 20 and each router 23 to 28 in the flow control system shown in FIG. 6. The processing comprises a step C1 of controlling routing information/QoS functional information, a step C2 of sending out routing control/QoS control command, and a step C3 of performing routing control/QoS control.

In the flow control system according to the second embodiment (the flow control system shown in FIG. 6), a flowchart showing the processing of the flow control server 1 is the same as that of the first embodiment shown in FIG. 3. Next, the operation of the whole flow control system according to this embodiment configured as described above will be described. Here, different points of the second embodiment from the first embodiment will be mainly described. In the first embodiment, the flow control is realized by controlling the routing information of each router 3 to 8. In the flow control system according to this embodiment, however, flow control is realized by carrying out QoS control such as priority control and disposal control, together with controlling routing information of each router 23 to 28. To realize such QoS control, as described above, the management server 20 and the routers 23 to 28 have the necessary QoS function. The management server 20 and the routers 23 to 28 of the second embodiment are identical to the management server 2 and the routers 3 to 8 of the first embodiment except for having the QoS function.

In this embodiment (second embodiment), the flow control server 1 carries out processing similar to that of the flow control server 1 according to the first embodiment (refer to FIG. 3).

Next, the management server 20 and each router 23 to 28 carry out the following operation (refer to FIG. 7). The management server 20 controls routing information and information related to the QoS function of each router 23 to 28 on the basis of a flow control command from the flow control server 1 (step C1 in FIG. 7). Then, the management server 20 sends out (issues) a routing control/QoS control command to each router 23 to 28 on the basis of the control of the step C1 (in such a manner as to command the routing information and the information related to the QoS function determined by the control to each router 23 to 28) (step C2). Each router 23 to 28 carries out routing control by setting its own (each router's 23 to 28) routing information on the basis of the routing control/QoS control command from the management server 20, and furthermore carries out QoS control on the basis of the routing control/QoS control command (step C3). Therefore, flow control according to this embodiment is realized.

Next, a third embodiment of the present invention will be described. A method for controlling a flow according to this embodiment, which is applied to a network system as shown in FIG. 2, comprises the following steps. In a first step, flow control information is set on a flow control server 1. In a second step, a traffic fluctuation information group is set on the flow control server 1. In a third step, the flow control server 1 monitors the presence or absence of change in the contents of traffic fluctuation information at regular intervals. In a fourth step, setting of the traffic fluctuation information is changed, when the presence of the change in the contents of the traffic fluctuation information is detected in the third step. In a fifth step, the flow control server 1 monitors the presence or absence of similar traffic fluctuation information at regular intervals. In a sixth step, the similar traffic fluctuation information is added to setting as new traffic fluctuation information, when the presence of the similar traffic fluctuation information is detected in the fifth step. In a seventh step, the flow control server 1 forecasts fluctuation in traffic on a network 100 on the basis of a latest traffic fluctuation information group, in which the change of setting in the fourth step and the addition of setting in the sixth step are reflected. In an eighth step, the flow control server 1 sends out a flow control command based on the forecast about traffic fluctuation in the seventh step to a management server 2. In a ninth step, the management server 2 controls routing information of each router 3 to 8 on the basis of the flow control command in the eighth step. In a tenth step, the management server 2 sends out a routing control command to each router 3 to 8 on the basis of the control of the routing information in the ninth step. In an eleventh step, each router 3 to 8 carries out routing control on the basis of the routing control command in the tenth step.

The processing procedure of the flow control method according to the third embodiment is similar to those of the foregoing flowcharts shown in FIGS. 3 and 4. In this case, the foregoing first to eighth steps correspond to the steps A1 to A8 of FIG. 3, respectively. The ninth to eleventh steps correspond to the steps B1 to B3 of FIG. 4, respectively.

The operation of the flow control method according to this embodiment is the same as the contents of operation (processing) shown in FIGS. 3 and 4, which are described in the explanation of the flow control system according to the foregoing first embodiment.

Next, a fourth embodiment of the present invention will be described. A method for controlling a flow according to the fourth embodiment will be first described. The flow control method according to the forth embodiment, which is applied to a network system as shown in FIG. 6, comprises the following steps. In a first step, flow control information is set on a flow control server 1. In a second step, a traffic fluctuation information group is set on the flow control server 1. In a third step, the flow control server 1 monitors the presence or absence of change in the contents of the traffic fluctuation information at regular intervals. In a fourth step, setting of the traffic fluctuation information is changed, when the presence of the change in the contents of the traffic fluctuation information is detected in the third step. In a fifth step, the flow control server 1 monitors the presence or absence of similar traffic fluctuation information at regular intervals. In a sixth step, the similar traffic fluctuation information is added to setting as new traffic fluctuation information, when the presence of the similar traffic fluctuation information is detected in the fifth step. In a seventh step, the flow control server 1 forecasts fluctuation in traffic on a network 100 on the basis of a latest traffic fluctuation information group, in which the change of setting in the fourth step and the addition of setting in the sixth step are reflected. In an eighth step, the flow control server 1 sends out a flow control command based on the forecast about traffic fluctuation in the seventh step to a management server (management server with QoS function) 20. In a ninth step, the management server 20 controls routing information and information related to the QoS function of each router (router with the QoS function) 23 to 28 on the basis of the flow control command in the eighth step. In a tenth step, the management server 20 sends out a routing control/QoS control command to each router 23 to 28, on the basis of the control of the routing information and the information related to the QoS function in the ninth step. In an eleventh step, each router 23 to 28 carries out routing control and QoS control on the basis of the routing control/QoS control command in the tenth step.

FIGS. 3 and 7 also correspond to flowcharts showing the processing procedure of the flow control method according to this embodiment.

In this case, the foregoing first to eighth steps correspond to the steps A1 to A8 of FIG. 3, respectively. The ninth to eleventh steps correspond to the steps C1 to C3 of FIG. 7, respectively.

The operation of the flow control method according to this embodiment is the same as the contents of operation (processing) shown in FIGS. 3 and 7, which are described in the explanation of the flow control system according to the foregoing second embodiment.

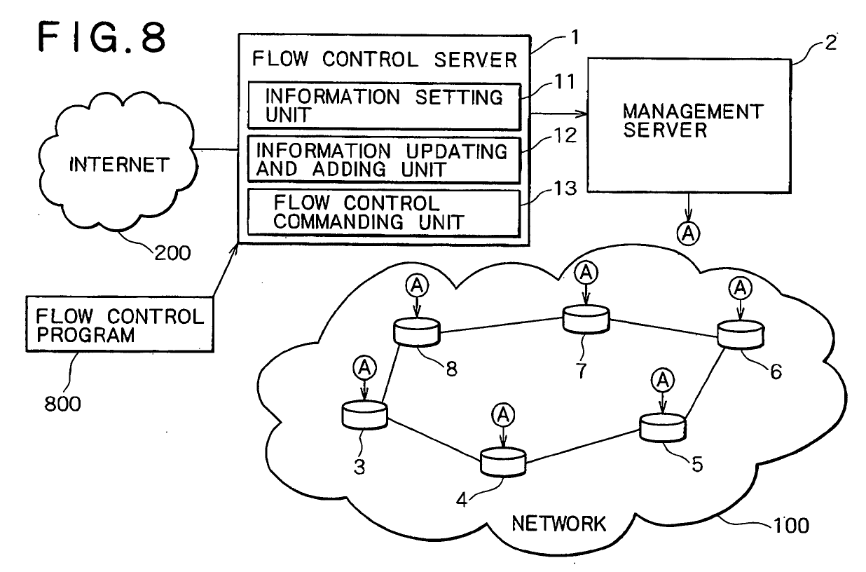

Next, a fifth embodiment of the present invention will be described. FIG. 8 is a block diagram showing a flow control system according to the fifth embodiment. As compared with the flow control system shown in FIG. 2, the flow control system according to the fifth embodiment has a flow control program 800. The flow control program 800 is read into a flow control server 1 of a network system, which comprises the flow control server 1, a management server 2, a network 100 with routers 3 to 8, and the Internet 200. The flow control program 800 controls the operation of the flow control server 1 as information setting unit 11, information updating and adding unit 12, and flow control commanding unit 13. The operation of the information setting unit 11, the information updating and adding unit 12, and the flow control commanding unit 13 by the control of the flow control program 800 is exactly same as the operation of the information setting unit 11, the information updating and adding unit 12, and the flow control commanding unit 13 in the flow control system shown in FIG. 2, so that detailed description thereof will be omitted.

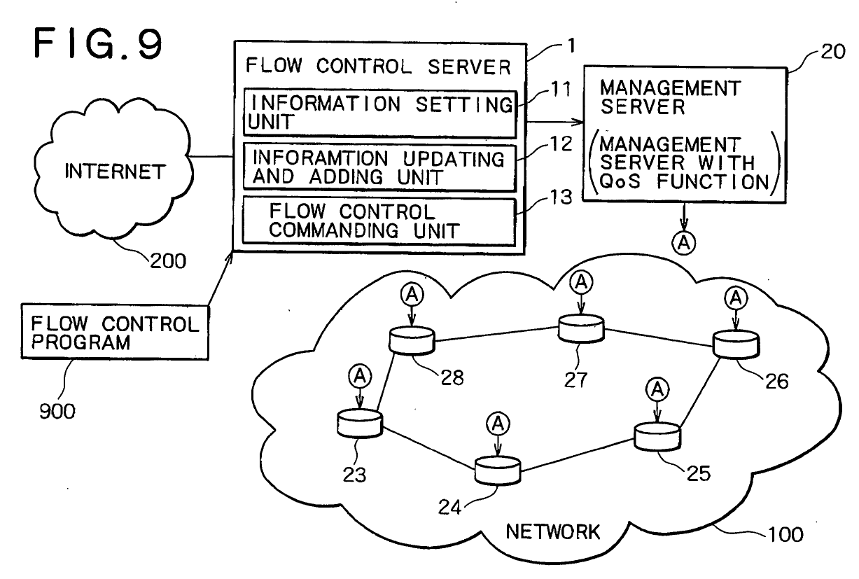

Next, a sixth embodiment of the present invention will be described. FIG. 9 is a block diagram showing a flow control system according to the sixth embodiment. As compared with the flow control system shown in FIG. 6, the flow control system according to the sixth embodiment has a flow control program 900. The flow control program 900 is read into a flow control server 1 of a network system, which comprises the flow control server 1, a management server (management server with QoS function) 20, a network 100 with routers (routers with the QoS functions) 23 to 28, and the Internet 200. The flow control program 900 controls the operation of the flow control server 1 as information setting unit 11, information updating and adding unit 12, and flow control commanding unit 13. The operation of the information setting unit 11, the information updating and adding unit 12, and the flow control commanding unit 13 by the control of the flow control program 900 is exactly same as the operation of the information setting unit 11, the information updating and adding unit 12, and the flow control commanding unit 13 in the flow control system shown in FIG. 6, so that detailed description thereof will be omitted.

1. A flow control system for controlling a flow on a network, which has a router group for carrying out a routing control, the flow control system comprising:
a flow control server for forecasting fluctuation in the traffic on the network to be controlled on the basis of a result of searching of an information set on itself and an information on the Internet, and issuing a flow control command on the basis of the forecast to prevent a congestion in said network; and
a management server for controlling a routing information of each router on the basis of said flow control command from said flow control server, and sending out a routing control command to said each router on the basis of the control, wherein
each of said routers carries out the routing control by setting its own routing information on the basis of the routing control command received from said management server, to realize the flow control.

2. A flow control system for controlling a flow on a network, which has a router group for carrying out a routing control, the flow control system comprising:
a flow control server, comprising:
an information setting unit for setting a flow control information and a traffic fluctuation information on the flow control server, the flow control information being necessary for carrying out flow control of the flow to be controlled, and indicating the contents of the flow, the traffic fluctuation information indicating a criterion of fluctuation in traffic on the network to be controlled,
an information updating and adding unit in the flow control server for updating the corresponding traffic fluctuation information, when the change in the contents of the preset traffic fluctuation information is detected on the basis of a result of searching information on the Internet, and for adding said similar traffic fluctuation information to the flow control server as a new traffic fluctuation information, when the presence of the similar traffic fluctuation information, which is the information similar/related to the traffic fluctuation information, is detected, and
a flow control commanding unit for forecasting the fluctuation in the traffic of each route on the network related to the flow to be controlled on the basis of a latest traffic fluctuation information group including update and addition by said information updating and adding unit, and for determining the contents of the flow control after that point in time on the basis of a forecast result, and sending out a flow control command indicating the contents of the control; and
a management server for controlling a routing information of said each router on the basis of said flow control command from said flow control server, and for sending out a routing control command, which indicates the routing information determined by the control, to said each router, wherein
said each of the routers carries out the routing control by setting its own routing information on the basis of the routing control command received from said management server, so that the flow control is realized.

3. A flow control system for controlling a flow on a network, which has a router group for carrying out a routing control, the flow control system comprising:
a flow control server, comprising:
an information setting unit for setting a flow control information and a traffic fluctuation information on the flow control server, the flow control information being necessary for carrying out flow control of the flow to be controlled, and indicating the contents of the flow, the traffic fluctuation information indicating a criterion of fluctuation in traffic on the network to be controlled,
an information updating and adding unit in the flow control server for updating the corresponding traffic fluctuation information, when the change in the contents of the preset traffic fluctuation information is detected on the basis of a result of searching information on the Internet, and for adding said similar traffic fluctuation information to the flow control server as a new traffic fluctuation information, when the presence of the similar traffic fluctuation information, which is the information similar/related to the traffic fluctuation information, is detected, and
a flow control commanding unit for forecasting the fluctuation in the traffic of each route on the network related to the flow to be controlled on the basis of a latest traffic fluctuation information group including update and addition by said information updating and adding unit, and for determining the contents of the flow control after that point in time on the basis of a forecast result, and sending out a flow control command indicating the contents of the control; and
a management server for controlling a routing information and an information related to a QoS function of each router on the basis of said flow control command from said flow control server, and sending out a routing control/QoS control command, which indicates the routing information and the information related to the QoS function determined by said control, to each router, wherein
said each router carries out the routing control by setting its own routing information on the basis of the routing control/QoS control command from said management server, and carries out QoS control on the basis of said routing control/QoS control command, in order to realize the flow control.

4. The flow control system according to claim 2, wherein
the traffic fluctuation information is an information indicating A, B, C, and D in a condition that “traffic increases in a certain route A at a certain date and time B on the basis of a certain reason C by an amount of D.”

5. The flow control system according to claim 3, wherein
the traffic fluctuation information is an information indicating A, B, C, and D in a condition that “traffic increases in a certain route A at a certain date and time B on the basis of a certain reason C by an amount of D.”

6. A method for controlling a flow in a network system in which a flow is controlled on a network having a router group for carrying out a routing control, the method comprising:
a first step of setting a flow control information on a flow control server;
a second step of setting a traffic fluctuation information group on the flow control server;
a third step of allowing the flow control server to monitor the presence or absence of the change in the contents of the traffic fluctuation information at regular intervals;
a fourth step of updating the traffic fluctuation information, when the presence of the change in the contents of the traffic fluctuation information is detected in said third step;
a fifth step of allowing the flow control server to monitor the presence or absence of a similar traffic fluctuation information at regular intervals;
a sixth step of adding the similar traffic fluctuation information as a new traffic fluctuation information, when the presence of the similar traffic fluctuation information is detected in said fifth step;
a seventh step of allowing the flow control server to forecast the fluctuation in traffic on the network to be controlled on the basis of a latest traffic fluctuation information group, in which update in said fourth step and addition in said sixth step are reflected;
an eighth step of allowing the flow control server to send out a flow control command on the basis of a forecast about the traffic fluctuation in said seventh step to a management server;
a ninth step of allowing the management server to the control routing information of each router on the basis of the flow control command in said eighth step;
a tenth step of allowing the management server to send out a routing control command to each router on the basis of the control of the routing information in said ninth step; and
an eleventh step of allowing each router to carry out the routing control on the basis of the routing control command in said tenth step.

7. A method for controlling a flow in a network system in which a flow is controlled on a network having a router group for carrying out a routing control, the method comprising:
a first step of setting a flow control information on a flow control server;
a second step of setting a traffic fluctuation information group on the flow control server;
a third step of allowing the flow control server to monitor the presence or absence of the change in the contents of the traffic fluctuation information at regular intervals;
a fourth step of updating the traffic fluctuation information, when the presence of the change in the contents of the traffic fluctuation information is detected in said third step;
a fifth step of allowing the flow control server to monitor the presence or absence of a similar traffic fluctuation information at regular intervals;
a sixth step of adding the similar traffic fluctuation information as a new traffic fluctuation information, when the presence of the similar traffic fluctuation information is detected in said fifth step;
a seventh step of allowing the flow control server to forecast the fluctuation in traffic on the network to be controlled on the basis of a latest traffic fluctuation information group, in which update in said fourth step and addition in said sixth step are reflected;
an eighth step of allowing the flow control server to send out a flow control command on the basis of a forecast about traffic fluctuation in said seventh step to a management server;
a ninth step of allowing the management server to a control routing information and an information related to a QoS function of each router on the basis of the flow control command in said eighth step;
a tenth step of allowing the management server to send out a routing control/QoS control command to each router, on the basis of the control of the routing information and the information related to the QoS function in said ninth step; and
an eleventh step of allowing each router to carry out the routing control and the QoS control on the basis of the routing control/QoS control command in said tenth step.

8. A program for use in a network system including a network having a router group for carrying out a routing control, on the precondition that a management server and routers are exist therein, the management server controlling a routing information of each router on the basis of a flow control command from a flow control server, and sending out a routing control command, which indicates the routing information determined by said control, to each router, said each router carrying out the routing control by setting its own routing information on the basis of the routing control command received from the management server, in order to realize a flow control,
the program making the flow control server function as:
an information setting means for setting a flow control information and a traffic fluctuation information on said flow control server, the flow control information being necessary for carrying out the flow control of a flow to be controlled, and indicating the contents of said flow, the traffic fluctuation information indicating a criterion of the traffic fluctuation on the network to be controlled;
an information updating and adding means for updating the corresponding traffic fluctuation information, when the change in the contents of the preset traffic fluctuation information is detected on the basis of a result of the searching information on the Internet, and for adding the similar traffic fluctuation information to the flow control server as a new traffic fluctuation information, when the presence of the similar traffic fluctuation information, which is the information similar/related to the traffic fluctuation information, is detected; and
a flow control commanding means for forecasting the fluctuation in traffic of each route on the network related to the flow to be controlled on the basis of a latest traffic fluctuation information group including update and addition by the information updating and adding means, and for determining the contents of the flow control after that point in time on the basis of a forecast result, and sending out a flow control command indicating the contents of the control to the management server.

9. A program for use in a network system including a network having a router group for carrying out a routing control, on the precondition that a management server and routers are exist therein, the management server controlling a routing information and an information related to a QoS function of each router on the basis of a flow control command from a flow control server, and sending out a routing control/QoS control command, which indicates the routing information and the information related to the QoS function determined by the control, to each router, each router carrying out routing control by setting its own routing information on the basis of the routing control/QoS control command from the management server, and carries out the QoS control on the basis of the routing control/QoS control command, in order to realize flow control,
the program making the flow control server function as:
an information setting means for setting a flow control information and a traffic fluctuation information on said flow control server, the flow control information being necessary for carrying out the flow control of a flow to be controlled, and indicating the contents of said flow, the traffic fluctuation information indicating a criterion of the traffic fluctuation on the network to be controlled;
an information updating and adding means for updating the corresponding traffic fluctuation information, when the change in the contents of the preset traffic fluctuation information is detected on the basis of a result of the searching information on the Internet, and for adding similar traffic fluctuation information to the flow control server as a new traffic fluctuation information, when the presence of the similar traffic fluctuation information, which is the information similar/related to the traffic fluctuation information, is detected; and
a flow control commanding means for forecasting the fluctuation in traffic of each route on the network related to the flow to be controlled on the basis of a latest traffic fluctuation information group including update and addition by the information updating and adding means, and for determining the contents of the flow control after that point in time on the basis of a forecast result, and sending out a flow control command indicating the contents of the control to the management server.
